(19) United States
(12) Patent Application Publication
(10) Pub. No.: US 2002/0049004 A1
(43) Pub. Date: Apr. 25, 2002

(54) Cluster block connector

(76) Inventors: Wayne Samuel Davis, Harrisburg, PA (US); Robert Neil Whiteman JR., Middletown, PA (US)

Correspondence Address: TYCO ELECTRONICS CORPORATION, MAIL STOP R20/2B, 307 CONSTITUTION DRIVE, MENLO PARK, CA, 94025, US

(21) Appl. No.: 09/875,586

(22) Filed: Jun. 6, 2001

Related U.S. Application Data
(60) Provisional application No. 60/210,617, filed on Jun. 9, 2000.

(51) Int. Cl. H01R 24/00

(52) U.S. Cl. 439/685

(57) ABSTRACT

A cluster block connector (10) includes a housing (12) having a base (14) and a cover (40), and a plurality of terminals (72), each being terminated to a respective conductor (70). The base (14) has a plurality of conductor receiving channels (22) having conductor surrounding portions (24) dimensioned to extend along a selected axial length and surround at least a portion of the conductor (70) disposed therein. The cover (40) includes a base receiving cavity (46) having a plurality of conductor surrounding elements (52) dimensioned to extend along a selected axial length and substantially surround a remaining portion of each of the conductors (70) upon the cover (40) being secured to the base (14) thereby substantially preventing contaminants from entering the conductor receiving channels (22).

### FIELD OF THE INVENTION

The present invention is directed to electrical connectors and more particularly to cluster block assemblies that are used for connection to a cluster of pin terminals.

### BACKGROUND OF THE INVENTION

Clusters of pin terminals are often used in hermetically sealed compressors such as those used for refrigerators, freezers, air conditioners and the like. The pin terminals form the electrical connection of the compressor motor to an external power supply. The pin terminals typically extend through the shell of the hermetically sealed compressor and are disposed in a cup-shaped metal body and secured to and insulated therefrom by glass insulating material. Examples of such connectors are shown, for example, in U.S. Pat. Nos. 3,842,396, 4,966,559 and 5,580,282. Portions of the terminals are exposed for mating to complimentary terminals that are terminated to conductors extending from the compressor motor. The motor and connectors are exposed to the refrigerant fluid, which may contain contaminants, such as, metallic particles that may cause a short circuit or other electrical problems if an electrical path is established to the terminals, and moisture, or degradation products of the refrigerant fluid that may attack the insulating material of the hermetically sealed terminals. It is desirable, therefore, that the connector and the interface between the connector and the pin terminals be resistant to entrance of contaminants. It is further desirable that the connector be cost effective to manufacture.

### SUMMARY OF THE INVENTION

The present invention is directed to a cluster block connector that resists entrance of contaminants into the mating connector as well as the connector interface. The connector includes a housing having a base and a cover, and a plurality of terminals disposed in terminal receiving cavities, each terminal being terminated to a respective conductor. The base of the housing includes a plurality of conductor receiving channels, each in communication with one of the terminal receiving cavities. Each channel has conductor surrounding portions dimensioned to extend along a selected axial length and surround around at least a portion of the conductor disposed therein. The cover of the housing includes a base receiving cavity having a plurality of conductor surrounding elements dimensioned to extend along a selected axial length and substantially surround around a remaining portion of the conductor disposed in the base channels upon the cover being secured to the base. Upon assembling the cover to the base the respective conductor surrounding portions of the base and conductor surrounding elements of the cover essentially surround the selected length of each of the conductors thereby substantially preventing contaminants from entering the conductor receiving channels.

One of the base and cover of the cluster block connector may further include a groove extending along the periphery thereof and the other of the base and cover include a cooperating rib extending along the periphery thereof and dimensioned to be received in the groove of the base thereby substantially preventing contaminants from entering the connector at the interface of the cover and base.

An embodiment of the invention will now be described by way of example with reference to the accompanying drawings.

### BRIEF DESCRIPTION OF THE DRAWINGS

FIG. 1 is an isometric view of a connector made in accordance with the present invention exploded from a cluster of pin terminals.

FIG. 2 is an isometric exploded view of the connector of FIG. 1 with the cover exploded from the housing base and illustrating the assembly face of the base.

FIG. 3 is an isometric exploded view of the connector of FIG. 1 with the cover exploded from the housing base and illustrating the underside of the cover.

FIG. 4 is a cross-sectional view of the connector taken along line 4-4 of FIG. 1 illustrating the position of the conductors in the conductor receiving channels.

FIG. 5 is a cross-sectional view of the connector taken along line 5-5 of FIG. 1 after the connector has been mated to the cluster of pin terminals illustrating the mating interface.

### DETAILED DESCRIPTION OF AN EMBODIMENT OF THE INVENTION

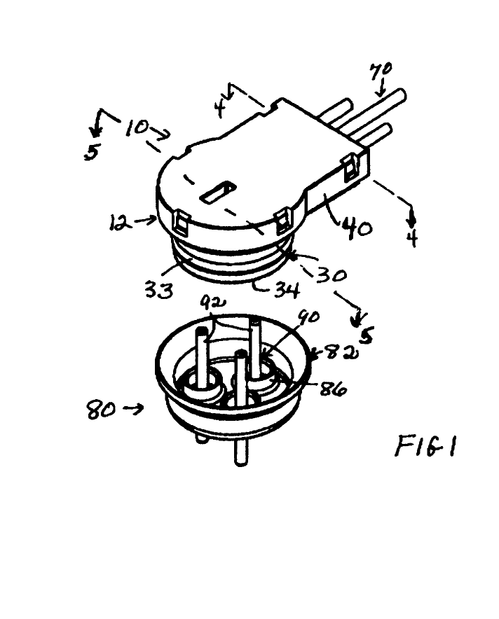

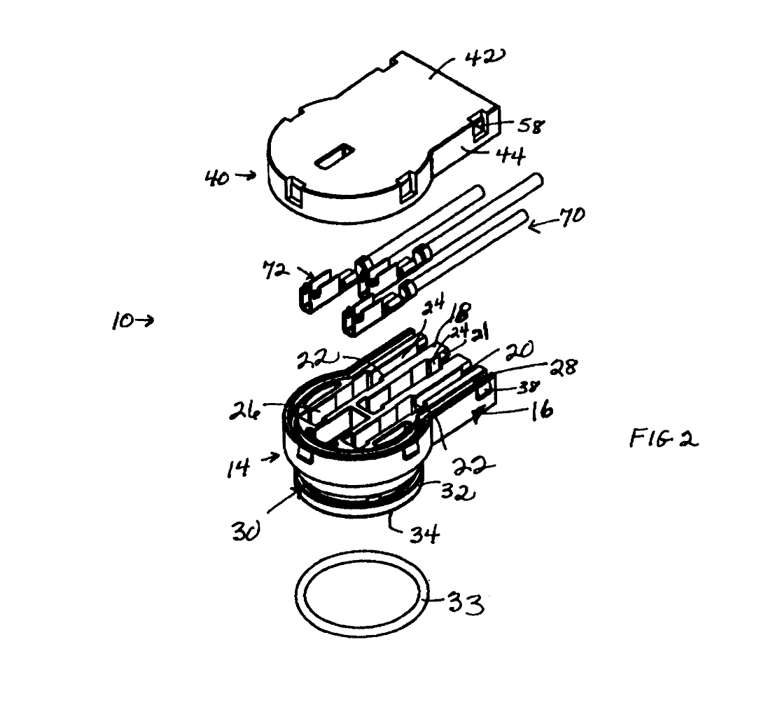

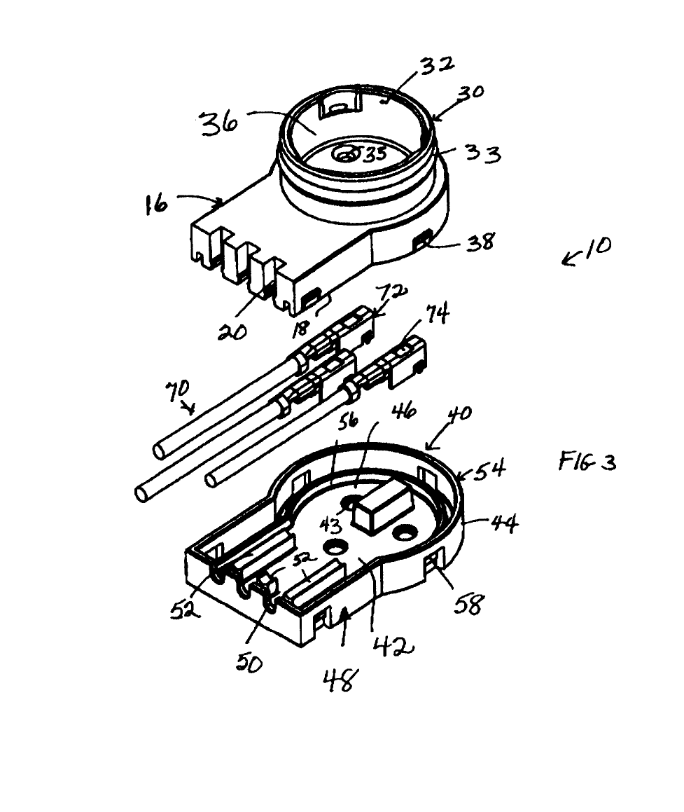

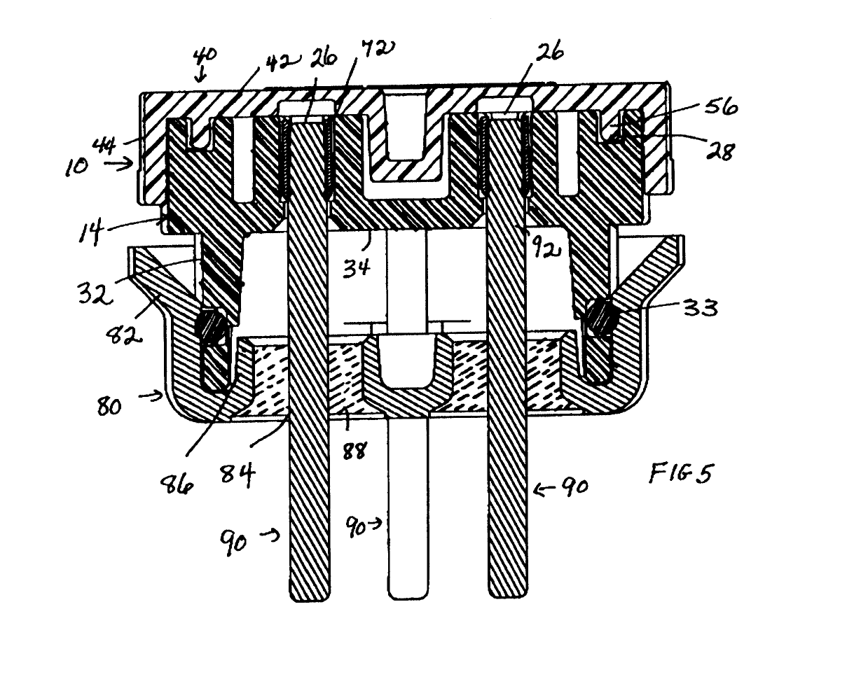

FIG. 1 illustrates connector 10 of the invention exploded from a pin terminal cluster 80 of the type that is mounted in an hermetically sealed compressor or the like. FIG. 5 illustrates connector 10 mated to pin terminal cluster 80. For purposes of illustration, the pin terminal cluster is shown with three pin terminals 90 extending through respective terminal receiving apertures 84, each pin being surrounded by a metal ring or wall 86 in a metal shell 82. Pin terminals 90 are secured in apertures 84 and insulated from the metal shell by glass insulation as shown in FIG. 5. It is to be understood that the pin terminal cluster and the mating connector of the present invention may contain a different number of terminals and may have different shapes that the ones illustrated. The internal structure of connector 10 is best seen by referring to FIGS. 2 and 3.

Connector 10 includes a housing 12 having a base 14, a cover 40, and a plurality of terminals 72 disposed in respective terminal receiving cavities 26. Each terminal 72 is terminated to a respective conductor 70. Base 14 includes a conductor receiving portion 16 having an assembly face 18 and a mating portion 30 having mating face 34. Assembly face 18 has a plurality of conductor receiving channels 22 each extending from a conductor receiving opening 20 to an associated terminal receiving cavity 26. Each channel 22 includes a conductor retention latch 21 adjacent the opening to hold a conductor 70 therein. Each channel 22 further includes conductor surrounding portions 24 that are dimensioned to extend a selected axial length and closely surround at least a portion of the conductor 70 disposed therein. Assembly face 18 further includes a rib receiving groove 28 extending around the periphery of the housing 14 that is dimensioned to receive a cooperating rib 56 of the cover 40, as more fully discussed below. Mating portion 30 includes a shroud 32 surrounding mating face 34 defining a mating cavity 36 and having a plurality of pin receiving apertures 35 extending therethrough. Housing 14 further includes a plurality of latches 38 spaced along the outer side surface of the housing dimensioned to cooperate with latch surfaces 58 of the cover 40, as more fully explained below.

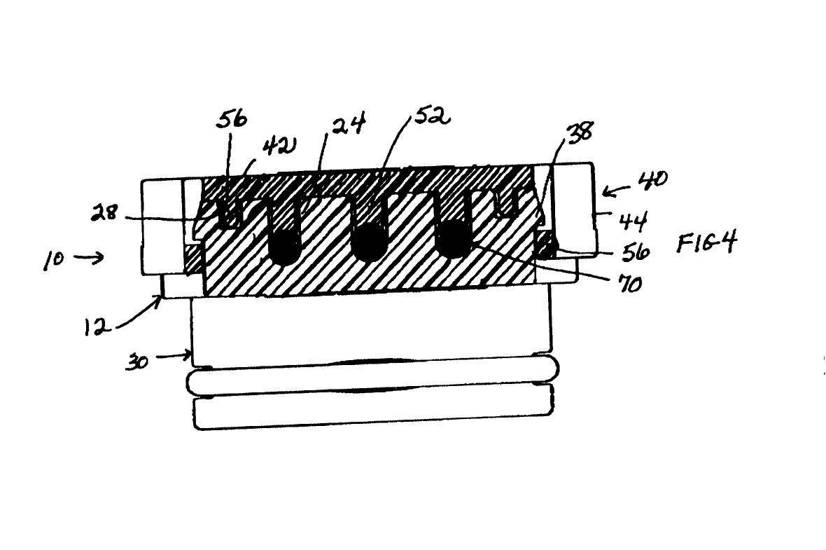

Cover 40 includes a top wall 42 having a side wall 44 extending therearound and that together define a base receiving cavity 46. Cover 40 includes a conductor receiving portion 48 having conductor surrounding elements 52 extending inwardly from conductor receiving openings in wall 44. A forward portion 54 of cover 40 includes recesses 43 extending into the top wall to provide clearance for mating ends 92 of terminal pins 90 upon connector 10 being mated to pin cluster 80. Cover 40 also includes a rib 56 extending around the periphery dimensioned to be received in groove 28 of base 14 upon base 14 being secured to cover 40, as shown in FIGS. 4 and 5. Upon mating connector 10 with pin cluster 80, connecting portions 92 of pin terminals 90 enter pin receiving apertures 35 and are electrically connected to terminals 72, as shown in FIG. 5.

Housing base 14 and cover 40 are molded from dielectric material suitable for use in compressors, as known in the art. Base 14 can be molded in a dual action mold and the cover 40 can be molded in a single action mold. Terminals 72 are stamped and formed from standard materials. As can be seen in FIG. 3, terminals 72 include pin receiving opening 74 for receiving connecting portion 92 of pin terminals 90 therein as shown in FIG. 5.

Connector 10 is assembled by terminating a terminal 72 onto the end of each conductor 70, positioning the terminals 72 in the respective terminal receiving cavities 26 of base 14 and the conductors 70 into conductor receiving channels 22 such that retention latch 21 is positioned over the conductor adjacent the wire receiving opening 20. After securing the members in base 14, cover 40 is secured in place by inserting latches 38 into recesses 58, as shown in FIG. 4. As can also be seen in FIG. 4, the conductor surrounding portions 24 of base 14 and the corresponding conductor surrounding elements 52 of cover 40 closely surround essentially the entire circumference of each conductor 70 thereby substantially preventing contaminants from entering the connector receiving channels 22. Additionally, rib 56 of the cover 40 is received in rib receiving groove 28 of the base 14 thereby substantially preventing contaminants from entering the connector 10 at the interface of the cover 40 and base 14. The base of groove 28 also forms an area that can trap contaminants that may enter the interface. The structure of the groove 28 and rib 56 provide a relatively long path of travel for any contaminants thereby keeping them out of the terminal receiving cavities 26 and mating cavity 36. It is to be understood that the base may be provided with the rib and the cover with the groove if desired. Furthermore, more than one rib and groove may be used if desired. FIG. 5 also shows the use of an optional O-ring 33 that may be used to seal the interface of connector 10 with pin terminal cluster 80.

The present invention provides a cluster block connector that substantially prevents contaminants from entering the conductor receiving channels and the interface between the housing base and cover thus preventing contaminants from entering the mating cavity of the connector with a pin terminal cluster via these paths. The connector is cost effective to manufacture.

It is thought that the cluster block connector of the present invention and many of its attendant advantages will be understood from the foregoing description. It is apparent that various changes may be made in the form, construction, and arrangement of parts thereof without departing from the spirit or scope of the invention, or sacrificing all of its material advantages.

We claim:

1. A cluster block connector comprising:
a housing having a base and a cover, and
a plurality of terminals disposed in terminal receiving cavities, each terminal being terminated to a respective conductor;
the base of the housing including a plurality of conductor receiving channels, each in communication with one of the terminal receiving cavities, each channel having conductor surrounding portions dimensioned to extend along a selected axial length and surround at least a portion of the conductor disposed therein;
the cover of the housing including a base receiving cavity having a plurality of conductor surrounding elements dimensioned to extend along a selected axial length and substantially surround a remaining portion of the conductor disposed in the channels of the base upon the cover being secured to the base;
whereby upon assembling the cover to the base the respective conductor surrounding portions of the base and conductor surrounding elements of the cover essentially surround the selected length of each of the conductors thereby substantially preventing contaminants from entering the conductor receiving channels.

2. The cluster block connector of claim 1 wherein each conductor receiving channel includes a retention latch proximate an associated conductor receiving opening to secure the conductor in the channel.

3. The cluster block connector of claim 1 wherein one of the housing base and cover further includes at least one groove extending along the periphery thereof and the other of the housing base and cover further includes at least one cooperating rib extending along the periphery thereof and dimensioned to be received in the corresponding groove thereby substantially preventing contaminants from entering the connector at the interface of the cover and base.

4. The cluster block connector of claim 3 wherein the base includes the groove and the cover includes the rib.

5. The cluster block connector of claim 3 wherein each conductor receiving channel includes a retention latch proximate an associated wire receiving opening to secure the conductor in the channel.

6. The cluster block connector of claim 1 wherein the cover and base are secured together by a plurality of latches spaced around the outer surfaces thereof.

7. A cluster block connector comprising:
a housing having a base and a cover, and
a plurality of terminals disposed in terminal receiving cavities, each terminal being terminated to a respective conductor;
one of the base and cover having at least one groove extending along the periphery thereof; and the other of the base and cover includes at least one cooperating rib extending along the periphery thereof and dimensioned to be received in the corresponding groove;
whereby upon assembling the base and cover together the rib is received in the groove thereby substantially preventing contaminants from entering the connector at the interface of the cover and base.

8. The cluster block connector of claim 7 wherein the base includes the groove and the cover includes the rib.

9. The cluster block assembly of claim 7 wherein the base of the housing includes an elongate conductor receiving portion having a plurality of conductor receiving channels in communication with the terminal receiving cavities, each channel having conductor surrounding portions dimensioned to extend along a selected axial length and surround at least a portion of the conductor disposed therein; and the cover of the housing includes a corresponding elongate conductor receiving portion having conductor surrounding elements dimensioned to extend along a selected axial length and substantially surround a remaining portion of the conductor disposed in the channels of the base upon the cover being secured to the base;
whereby upon assembling the cover to the base the respective conductor surrounding portions of the base and conductor surrounding elements of the cover essentially surround the selected length of each of the conductors thereby substantially preventing contaminants from entering the conductor receiving channels.

10. The cluster block connector of claim 7 wherein the cover and base are secured together by a plurality of latches spaced around the outer surfaces thereof.
